(19) United States
(12) Patent Application Publication
(10) Pub. No.: US 2021/0319336 A1
(43) Pub. Date: Oct. 14, 2021

(54) MATERIAL PROPERTY PREDICTION METHOD AND MATERIAL PROPERTY PREDICTION DEVICE

(71) Applicant: Hitachi, Ltd., Tokyo (JP)

(72) Inventor: Tasuku YANO, Tokyo (JP)

(21) Appl. No.: 17/204,007

(22) Filed: Mar. 17, 2021

(30) Foreign Application Priority Data
Apr. 8, 2020 (JP) 2020-069680

(51) Int. Cl. G06N 5/04; G06N 20/00

(52) U.S. Cl. CPC G06N 5/04; G06N 20/00

(57) ABSTRACT

Provided are a material property prediction method and a material property prediction device capable of material search considering the interaction between partial structures by using explanatory variables that can be determined without using measured values. A material property prediction method using machine learning that builds a prediction model of the objective variable from explanatory variables based on a partial structure of a material, the material property prediction method including (a) a step of performing a first-principles calculation based on the partial structure of the material and randomly selected explanatory variables, and (b) a step of performing unsupervised classification machine learning and supervised learning based on the result of the first-principles calculation obtained in the above step (a) to build a prediction model, in which the sum of squares of the values obtained by the first-principles calculation is included in the explanatory variables in the step (b).

### CLAIM OF PRIORITY

The present application claims priority from Japanese Patent application serial no. 2020-069680, filed on Apr. 8, 2020, the content of which is hereby incorporated by reference into this application.

### TECHNICAL FIELD

The present invention relates to a material search method based on property prediction and particularly relates to a technique effective for a material search for organic compounds.

### BACKGROUND ART

In fields such as catalysts, metal alloys, thermoelectric materials, and battery materials, where many elements are complicatedly related, shortening the developing period by improving the efficiency of material search has become an important issue. In the related arts, material development was carried out by combining computational science, material synthesis and evaluation, and a database in which material data has been accumulated, but in recent years, new material development using data science is also underway, such as material search in which machine learning and deep learning are added to the large amount of data obtained by automation of computational science and text mining.

As background technology in the technical field, for example, there are technologies such as International Publication No. 2003/038672 (PTL 1) and JP-A-2007-257084 (PTL 2). PTL 1 and PTL 2 propose a method for searching for organic materials using machine learning. The material searches are for searching for materials whose material properties satisfy certain conditions.

Here, the characteristic value for which the condition is imposed is often unknown, and the material search method includes the building of a characteristic value prediction model and the characteristic value prediction using the model. The characteristic value desired to be predicted is called the objective variable and the variable used for prediction is called the explanatory variable. In such material search, a model for obtaining the objective variable from the explanatory variables is built by using the characteristic values of the materials whose objective variables are known among all the materials to be searched, and the unknown objective variable is predicted using the model, and then, a desirable material from the population of all materials is selected.

In PTL 1, pharmacophore descriptors, EHIM descriptors, substituent length, substituent width, molecular refraction MR, Hammett substituent constants, Swain-Lupton's electron effect parameters, dissociation constants, partial electron charges, Hansch's hydrophobic constants, substituent hydrophobic constants, partition coefficient log P, hydrophobic index measured by HPLC, calculated value of log P CLOGP, the number of hydrogen bond receptions, the number of hydrogen bond donor groups, the total number of possible hydrogen bonds, and the like are used as explanatory variables for the purpose of searching for a material having high pharmacological activity.

In PTL 2, the number of 99 kinds of partial structures is used as a part of the explanatory variables for the purpose of searching for biodegradable materials.

### CITATION LIST

### Patent Literature

PTL 1: International Publication No. 2003/038672

PTL 2: JP-A-2007-257084

### SUMMARY OF INVENTION

### Technical Problem

As described above, a method for searching for organic materials using machine learning has been proposed, but in the method of PTL 1, among the explanatory variables, molecular refraction MR, Hammett substituent constants, Swain-Lupton electronic effect parameters, dissociation constants, Hansch's hydrophobic constants, substituent hydrophobic constants, partition coefficient log P, hydrophobic index measured by HPLC are all measured values. Therefore, the method cannot be used without such measured values.

On the other hand, in the method of PTL 2, the values of the explanatory variables can be determined for any molecule and the undetermined value of the explanatory variable as described above does not occur. However, the explanatory variable is the number of substructures and the interaction between multiple homologous substructures is not considered.

Therefore, an object of the present invention is to provide a material property prediction method and a material property prediction device capable of searching for material considering the interaction between partial structures by using explanatory variables that can be determined without using measured values.

### Solution to Problem

In order to solve the above problems, the present invention is a material property prediction method using machine learning that builds a prediction model of an objective variable from explanatory variables based on a partial structure of a material, the material property prediction method including (a) a step of performing a first-principles calculation based on the partial structure of the material and randomly selected explanatory variables, and (b) a step of performing unsupervised classification machine learning and supervised learning based on the result of the first-principles calculation obtained in the above (a) step to build a prediction model, in which the sum of squares of the values obtained by the first-principles calculation is included in the explanatory variables in the step (b).

The present invention is a material property prediction device using machine learning that builds a prediction model of an objective variable from explanatory variables based on a partial structure of a material, the material property prediction device including an input unit for inputting a molecular set of a target material and selecting explanatory variables, a calculation unit for building a prediction model based on the partial structure of the material and the selected explanatory variables, and an output unit for outputting the calculation result in the calculation unit, in which the calculation unit includes a first-principles calculation unit that performs first-principles calculations based on the partial structure of the material and the selected explanatory variables, and an machine learning unit that performs unsupervised classification machine learning and supervised learning based on the calculation results in the first-principles calculation unit to build a prediction model, and the sum of squares of the values obtained by the first-principles calculation unit is included in the explanatory variables when building a prediction model in the machine learning unit.

### Advantageous Effects of Invention

According to the present invention, it is possible to realize a material property prediction method and a material property prediction device capable of searching for material considering the interaction between partial structures by using explanatory variables that can be determined without using measured values.

As a result, in material development in various fields, the development period can be shortened by improving the efficiency of material search.

Problems, configurations, and effects other than those described above will be clarified by the description of the following embodiments.

### BRIEF DESCRIPTION OF DRAWINGS

FIG. 1 is a diagram showing an outline of a material search according to Example 1 of the present invention.

FIG. 2 is a diagram showing machine learning according to Example 1 of the present invention.

FIG. 3 is a diagram showing model-building materials according to Example 1 of the present invention.

FIG. 4 is a diagram showing the electric charges of the model-building materials of FIG. 3.

FIG. 5 is a diagram showing bond orders of the model building materials of FIG. 3.

FIG. 6A is a diagram showing a relationship between a bond order and a sum of charges, and FIG. 6B is a diagram showing a relationship between a bond order and a sum of squared charges.

FIG. 7 is a flowchart showing a material search method (material property prediction method) according to Example 1 of the present invention.

FIG. 8 is a diagram showing a selection method (selection screen) of explanatory variables according to Example 1 of the present invention.

FIG. 9 is a diagram showing a characteristic example of the model-building materials of FIG. 3.

FIG. 10 is a diagram showing an example of a polyatomic partial structure.

FIG. 11 is a block diagram showing a schematic configuration of a material search device (material property prediction device) according to Example 2 of the present invention.

### DESCRIPTION OF EMBODIMENTS

Hereinafter, examples of the present invention will be described with reference to the drawings. In each drawing, the same components are designated by the same reference numerals and the detailed description of duplicated portions will be omitted.

### Example 1

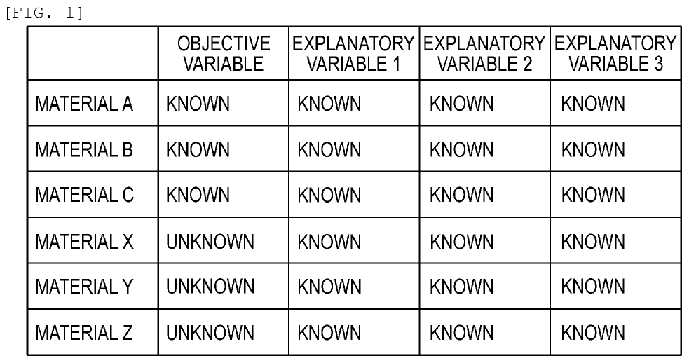

The material search method (material property prediction method) according to Example 1 of the present invention will be described with reference to FIGS. 1 to 10.

First, the outline of material search using machine learning will be described with reference to FIG. 1. As shown in FIG. 1, it is assumed that all the explanatory variables are known for the candidate materials A, B, C, X, Y, and Z, and the objective variables are known for the materials A, B, and C and are unknown for the materials X, Y and Z. Here, in the material search using machine learning, first, a model in which the objective variable is represented by the explanatory variables is built by using the objective variables and the explanatory variables of the materials A, B, and C. Next, based on the above model, the objective variables of materials X, Y, and Z are predicted using the explanatory variables of materials X, Y, and Z. Finally, among the materials A, B, C, X, Y, and Z, the material with a good objective variable is selected.

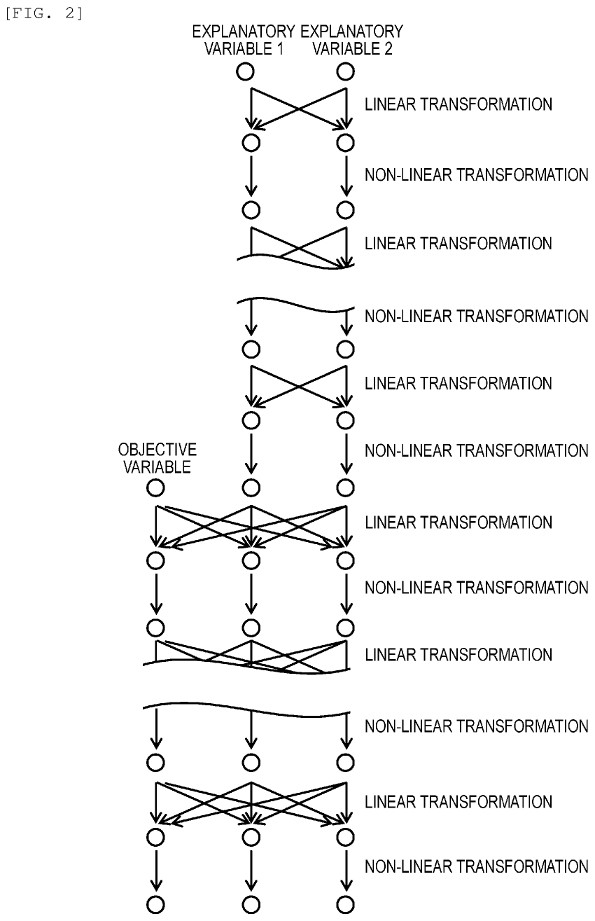

Next, the outline of machine learning will be explained with reference to FIG. 2. As shown in FIG. 2, in the machine learning of the present example, learning is performed in a multi-layer structure. In the first half of the multi-layer structure, the objective variable is not used (unsupervised learning) and the explanatory variables or the variables derived from the explanatory variables are classified into multiple groups. In the latter half, a group that correlates with the objective variable is selected from each classified group to build a prediction model. The transformation of each layer consists of a linear transformation and a non-linear transformation. Here, the coefficient of the linear transformation is obtained by the linear analysis, and the coefficient of the non-linear transformation is obtained by the non-linear analysis.

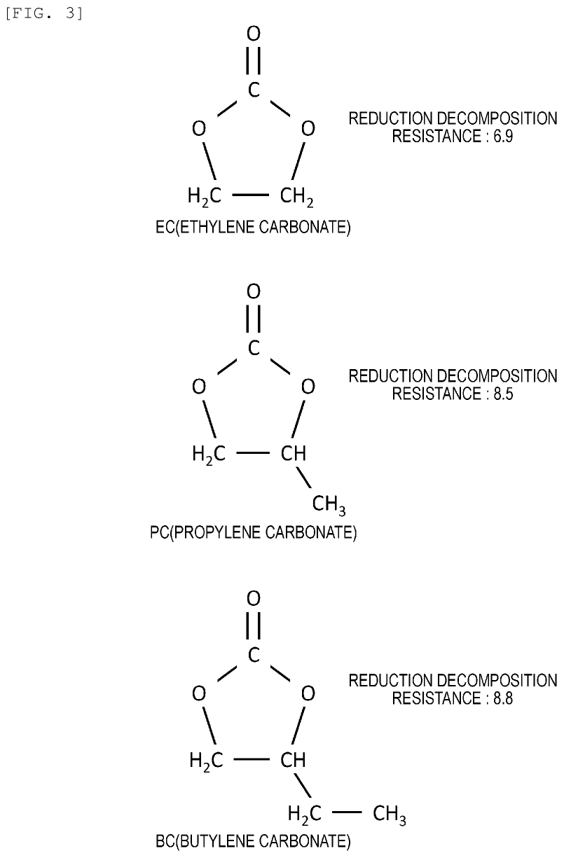

In the present example, for the purpose of extending the life of the lithium-ion battery, a material search for a carbonate compound whose reduction decomposition is difficult will be described as an example. Here, the materials used for building a prediction model, that is, the materials whose objective variables are known are EC (ethylene carbonate), PC (propylene carbonate), and BC (butylene carbonate) shown in FIG. 3.

The objective variable is the reduction decomposition resistance, which is 6.9 for EC, 8.5 for PC, and 8.8 for BC, as shown in FIG. 3. Such reduction decomposition resistances are the activation energies of the reduction decomposition reaction obtained by the first-principles calculation and the unit thereof is kcal/mol. Among EC, PC, and BC, those with high resistance to reduction decomposition are PC and BC. Therefore, the features that machine learning should find are features contained in PC and BC but not in EC.

Since it is known that the reduction decomposition reaction of the present example is a dissociation of C—O bonds, the description will be limited to C—O bonds for the sake of clarity.

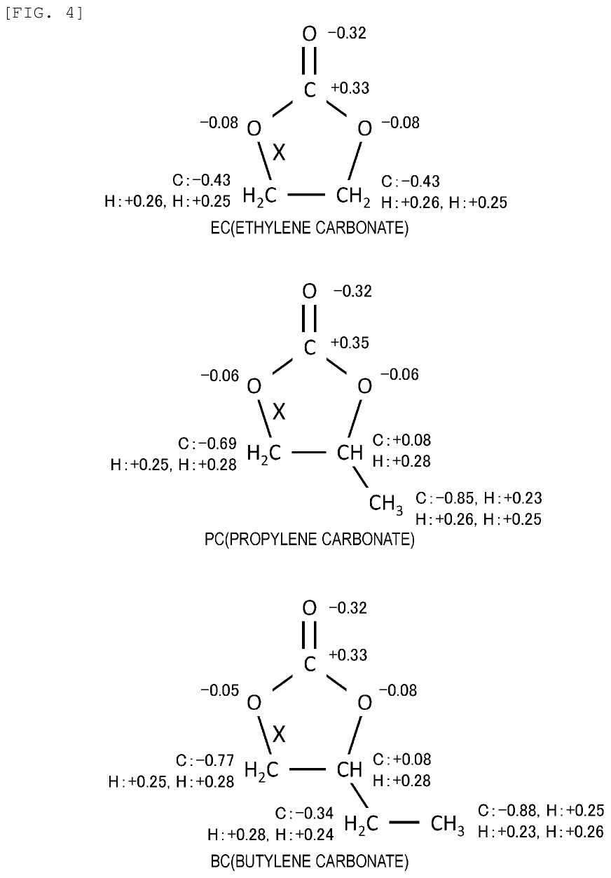

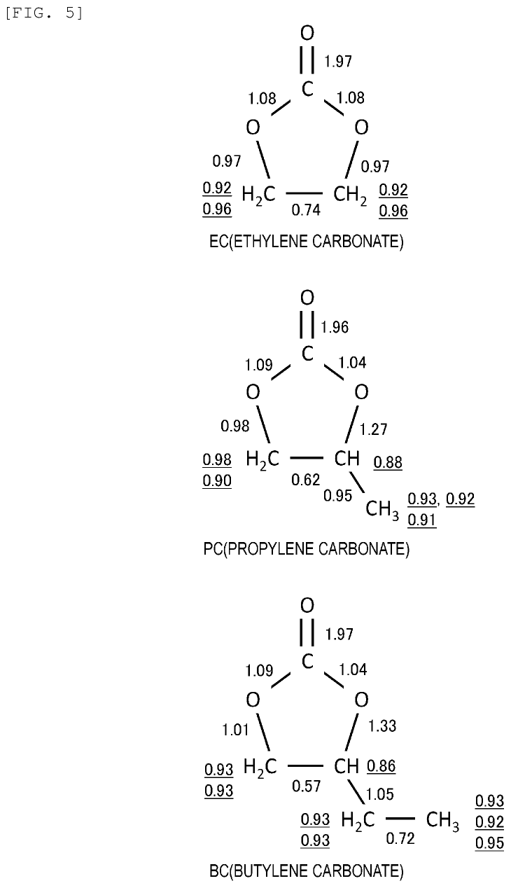

Below, the description will be made for the features that machine learning should find from the results of first-principles calculations. The results of reading out the charge of each atom and the bond order between each atom from the results of the first-principles calculation are shown in FIGS. 4 and 5, respectively. The underlined numbers in the bond order of FIG. 5 indicate the bond order of C—H.

Here, the first-principles calculation is for molecules and is based on the density functional theory using atomic orbital basis functions. The charge is obtained by the Mulliken method and the bond order is obtained by the Mayer method.

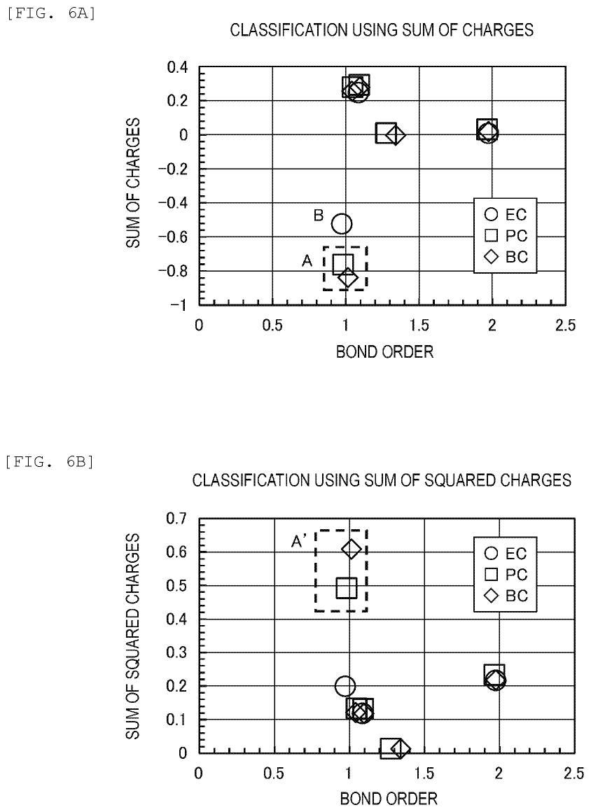

Of the charges and bond orders obtained by first-principles calculation, focusing on the partial structure of the C—O bond, the sum of the charge of C (carbon) and the charge of O (oxygen), that is, the sum of charges was obtained. The C—O bond in each compound is shown in FIG. 6A, with the vertical axis representing the sum of charges and the horizontal axis representing the bond order. In FIG. 6A, circles (◯) indicate the C—O bonds in EC, quadrangles (□) indicate the C—O bonds in PC, and diamonds (⋄) indicate the C—O bonds in BC.

As shown in group A in FIG. 6A, PC and BC resistant to reduction decomposition have a C—O bond having a bond order of 0.9 to 1.1 and a sum of charges of −0.7 to −0.9. As shown in group B in FIG. 6A, there is a C—O bond of EC having a bond order of 0.9 to 1.1 and a sum of charges of −0.4 to −0.6 near group A.

Next, the sum of the square of the charge of C (carbon) and the square of the charge of O (oxygen), that is, the sum of the squared charges was obtained. FIG. 6B shows data plotted with the vertical axis as the sum of squared charges.

The features of PC and BC, which have high resistance to reduction decomposition, appeared in a bond order of 0.9 to 1.1 and a sum of squared charges of 0.3 to 0.8, as shown by A′ in FIG. 6B. No other type of bonds was found near these.

Since the features that machine learning should find are not in EC but in PC and BC, the features are group A in FIG. 6A or group A′ in FIG. 6B.

The prediction model when group A is found is:

Y=6.90−1.11×X1−3.56×X2

The prediction model when group A′ is found is:

Y=6.90+0.783×X1+1.75×X3

Here, Y is the reduction decomposition resistance, X1 is the bond order, X2 is the sum of charges, and X3 is the sum of squared charges.

A prediction model can be built regardless of whether machine learning finds group A or group A′. However, as shown in FIG. 6A, there is group B near group A, but as shown in FIG. 6B, there are no other bonds near group A′, and thus, group A′ can be easily found, that is, the feature can be easily found by using the sum of squared charges.

Here, the reason will be explained. One of the features of group A′ in FIG. 6B is that the sum of squares of charges is large. This is interpreted back to the charge of FIG. 4. It can be seen that the bond of X in FIG. 4 is negatively charged in the order of EC, PC, and BC, but the negative charge is biased toward C (carbon), and the polarization of the bond increases. As described above, since the sum of squares changes not only with the charge of the partial structure but also with the state of polarization, it is considered that the feature is likely to appear in the sum of squared charges.

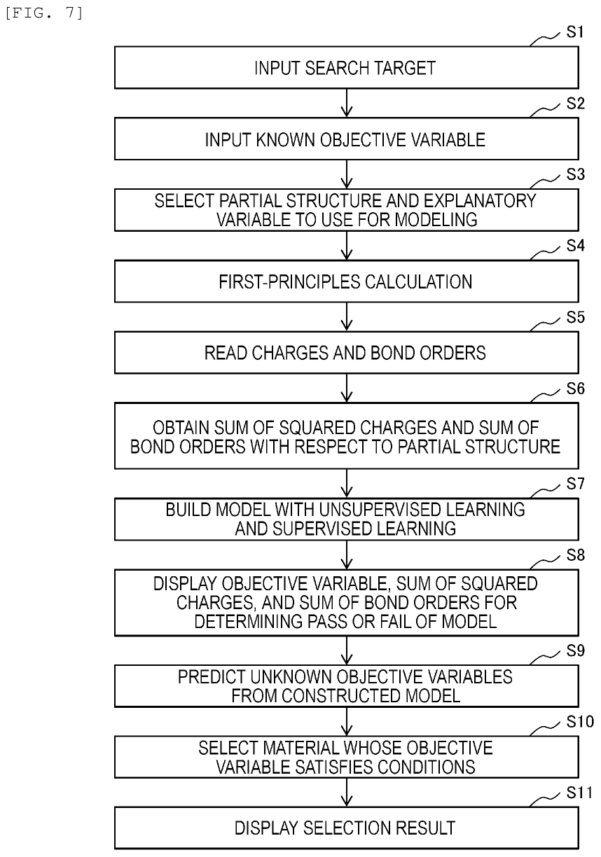

The material search method (material property predict ion method) of the present example will be described with reference to the flowchart of FIG. 7.

First, in step S1, the material to be searched is input.

Next, in step S2, the objective variable is input for the material whose objective variable is known among the materials to be searched. In the present example, reduction decomposition resistance is the objective variable.

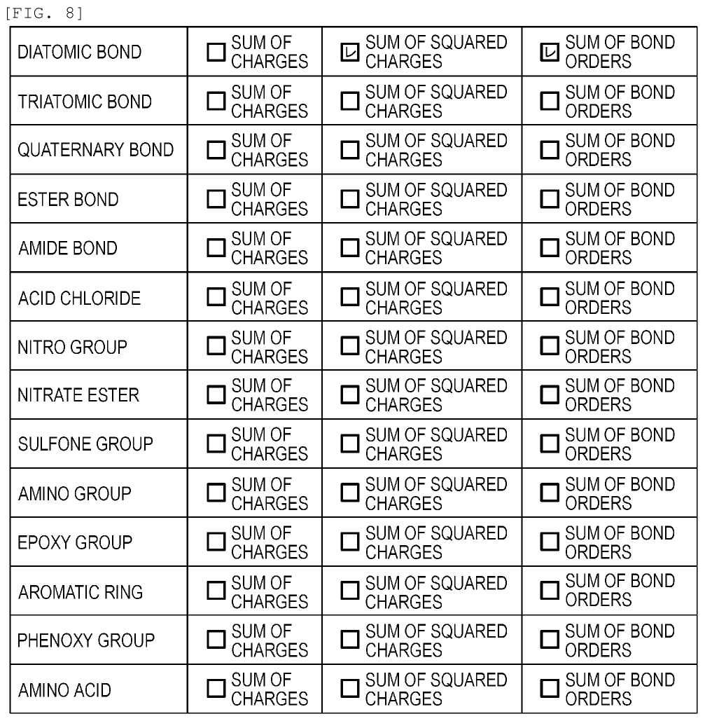

Then, in step S3, from the input screen (selection screen) as shown in FIG. 8, the partial structure used for building a prediction model and the one to be selected as the explanatory variable from each partial structure are selected. The input screen (selection screen) of FIG. 8 is displayed, for example, in an input unit 2 described later in Example 2.

In the example of FIG. 8, as the partial structure, a diatomic bond, a triatomic bond, a quaternary bond, various functional groups, and an amino acid can be selected, and the sum of charges, the sum of squared charges, and the sum of bond orders can be selected for each partial structure. Here, the sum of squared charges and the sum of bond orders of diatomic bonds are selected.

Next, in step S4, the first-principles calculation is performed for all materials of the compound group. Here, it is preferable to include structural optimization.

Subsequently, in step S5, the charge of each atom and the bond order between the atoms in each material are read out from the result of the first-principles calculation.

Next, in step S6, for each partial structure of each material, the sum of squared charges and the sum of bond orders are obtained.

Subsequently, in step S7, unsupervised classification machine learning is performed, a group that correlates with reduction decomposition resistance is selected, and a prediction model is built by supervised learning.

Next, in step S8, in order for the user to determine the pass or fail of the prediction model, the sum of squared charges, the sum of bond orders, and the reduction decomposition resistance, which is the objective variable, are displayed for the material whose objective variable is known. For example, it is displayed on an output unit (display unit) 7 described later in Example 2.

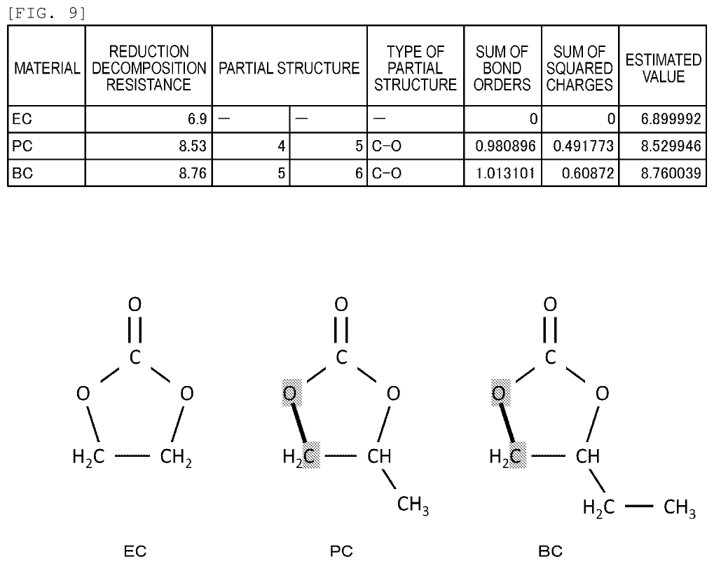

As shown in FIG. 9, the partial structure of the material used for model building is displayed. In the example of FIG. 9, since the C—O bond at the lower left of PC and BC is used for model building, the corresponding C—O bond is displayed thick and the corresponding C and 0 are marked. Since EC does not have a partial structure showing reduction decomposition resistance, there are no thickly displayed bonds or marked atoms.

Subsequently, in step S9, the unknown objective variable (reduction decomposition resistance) is predicted using a prediction formula (prediction model).

Finally, in step S10, the material with the highest reduction decomposition resistance (material whose objective variable satisfies the condition) including the predicted reduction decomposition resistance is selected, and in step S11, the selection result is displayed.

In step S6, when the sum of charges was used instead of the sum of squares of charges, groups A and B in FIG. 6A were combined into one group at the time of unsupervised learning of the classification type. As a result, no correlation with reduction decomposition resistance was found in step S8. Here, step S6 can be modified and re-executed.

In the present example, since the reaction of interest was known to be the cleavage of the C—O bond, the partial structure was limited to the C—O bond. However, if the reaction of interest is unknown, other diatomic bonds such as C—H bond and C—C bond may be included. Here, since the types of C—O bond, C—H bond, and C—C bond can be distinguished only by the type of atoms, unsupervised learning in step S7 may be performed for each type of bond.

When defining the partial structure with a diatomic bond, it is not necessary to distinguish between a primary bond, a secondary bond, and a tertiary bond. It is because the bond order is obtained by the first-principles calculation performed later and classification is performed by machine learning.

In the present example, the objective variable was the reduction decomposition resistance, and the reduction decomposition resistance was set to be the activation energy obtained by the first-principles calculation. However, the reduction decomposition resistance may be a measured value of battery life. Although the objective variable is set to be the reduction decomposition resistant, the present invention can be applied as long as the objective variable can be measured or calculated.

In step S3, the partial structure is limited to the diatomic bond, but the partial structures of the triatomic bond and the quaternary bond may be used. The effect of bond angles can be considered when a partial structure of a triatomic bond is used, and the bond twist can be considered when a partial structure of a quaternary bond is used.

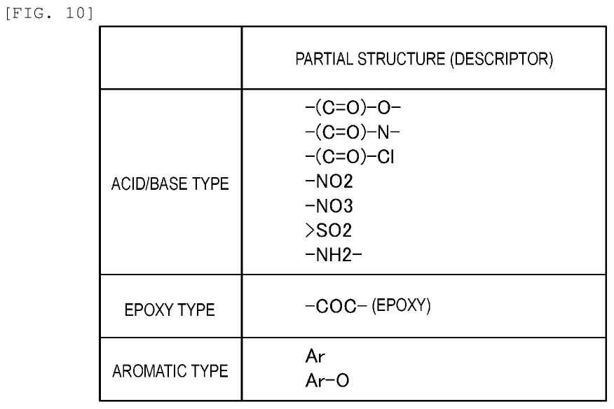

In step S3, the partial structure may include functional groups such as ester bond, amide bond, acid chloride, nitro group, nitrate ester, sulfone group, amino group, epoxy group, aromatic ring, and phenoxy group shown in FIG. 10. Using such functional groups, the effects of many atoms can be represented by a small number of explanatory variables.

Amino acids may be used as the partial structure. Here, the number of explanatory variables can be greatly reduced in the material search for polypeptides and proteins. The user may freely add partial structures such as functional groups and amino acids.

In the present example, the sum of charges was not selected in step S3, but the sum of charges may be selected. When the sum of charges is selected, the number of explanatory variables increases, and thus, the accuracy of the prediction formula (prediction model) may be improved.

In step S3, not only the explanatory variables based on the partial structure but also the ionization potential, electron affinity, and molecular volume for the molecule may be included. Steric hindrance obtained by molecular dynamics may be included.

In step S5, the first-principles calculation was performed for the structure without a periodic boundary using the atomic orbital basis function, the charge was obtained by the Mulliken method, and the bond order was obtained by the Mayer method. However, the charge and bond order may be determined by other methods. For example, the Lowdin method can be used to determine the charge, and the Mulliken method can be used to determine the bond order.

It is also possible to perform the first-principles calculation for the structure with a periodic boundary using the atomic orbital basis function. Here, the charge and bond order can be obtained as in the case of the structure without a periodic structure. For a structure having a periodic boundary, the first-principles calculation may be performed using a plane wave basis function. Here, the wave function obtained by a linear combination of plane waves can be converted to the atomic orbital basis function by a method of projection or the like to obtain the charge and bond order. The present invention is applicable to polymer compounds when performing first-principles calculations for structures with periodic boundaries.

Here, an advantage of using the sum of squares is explained in detail. The sum of squares is used in the present embodiment, but a sum of cubes, a sum of fourth powers and the like may be used. However, the computational load is smallest in the case of the sum of squares.

In step S6, when only the sum of charges was selected, the feature extraction of reduction decomposition resistance failed. It is because, as shown in FIG. 6A, there is a bond of group B having no reduction decomposition resistance near group A, which is a feature of reduction decomposition resistance. On the other hand, when the sum of squares of charges is used, as shown in FIG. 6B, since there are no other bonds near group A′, which is a feature of reduction decomposition resistance, machine learning can easily make group A′ into one cluster, and then the cluster can be determined as a feature of reduction decomposition resistance.

The feature of the sum of squares of charges tends to appear because the sum of squares changes not only with the charge of the partial structure but also with the state of polarization.

As described above, it is one of the advantages of using the sum of squares of charges that clusters with a strong correlation with the objective variable can be easily found.

As explained in FIG. 2, each layer of machine learning is a linear analysis and a non-linear analysis. Therefore, the first part of the first layer of machine learning is linear analysis. In the linear analysis, the correlation analysis between the explanatory variables is obtained, and for that purpose, the product between the explanatory variables is calculated. Here, since the square of one variable is also calculated, it is not necessary to newly calculate the square. Therefore, the increase in the computational load of machine learning is reduced. It is one of the advantages of using the sum of squares.

When a multi-atomic partial structure as shown in FIG. 10, for example, a phenyl group (C₆H₅—) is used, in order to express the polarization, the type of polarization, that is, a dipole, a quadrupole, a hexapole, or the like must be clarified, which is difficult to automate. However, since the sum of squares of charges changes regardless of the type of polarization, automation is easy if the sum of squares is used.

Although the material search is performed in the present example, the material properties can be predicted by omitting steps S10 and S11 in FIG. 7. Such material property prediction is useful when the material to be used has already been determined and the properties of that material are desired to be known.

Although the sum of squares of charges is used as an explanatory variable in the present example, the sum of squares of values other than charges may be added. For example, if the sum of squares of bond orders is included, a benzene ring consisting of six equivalent 1.5 bonds can be distinguished from a cyclic triene consisting of three single bonds and three double bonds.

In the present example, the reduction decomposition resistance is predicted, but it is to predict the difficulty of the reaction, and it can be said that the reaction rate is predicted. The predicted reaction rate can be used for the design of production equipment, for example, the size of the reaction vessel, the reaction time, and the like. If the rate of deterioration reaction of the product is predicted, the rate can be used for predicting the life of the product.

As described above, the material property prediction method of the present example is a material property prediction method using machine learning that builds a prediction model of an objective variable from explanatory variables based on a partial structure of a material, the material property prediction method including (a) a step of performing a first-principles calculation based on the partial structure of the material and randomly selected explanatory variables, and (b) a step of performing unsupervised classification machine learning and supervised learning based on the result of the first-principles calculation obtained in the above step (a) to build a prediction model, wherein the sum of squares of the values obtained by the first-principles calculation is included in the explanatory variables in the step (b).

It is possible to predict material properties and search for materials considering the interaction between partial structures, using explanatory variables that can be determined without using measured values.

### Example 2

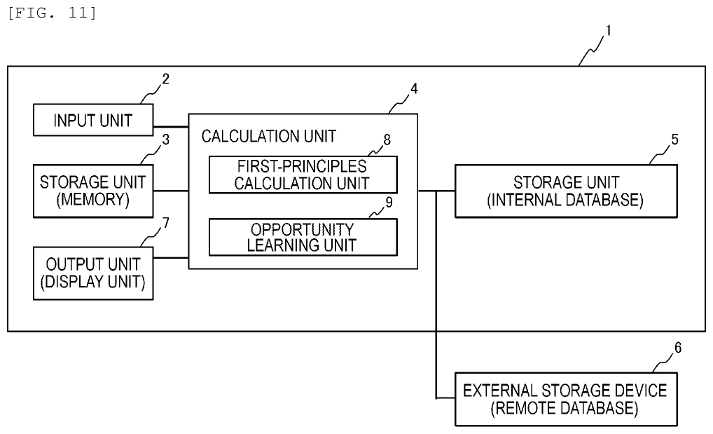

The material search device (material property prediction device) according to Example 2 of the present invention will be described with reference to FIG. 11. FIG. 11 shows a device configuration for executing the method described in Example (FIG. 7).

As shown in FIG. 1, a material property prediction device 1 of the present example includes, as main configurations, an input unit 2, a storage unit (memory) 3, a calculation unit 4, a storage unit (internal database) 5, and an output unit (display unit) 7. The calculation unit 4 includes a first-principles calculation unit 8 and a machine learning unit 9.

The molecular set of the material to be searched and the known objective variable of the material are input from the input unit 2 to the calculation unit 4. The known objective variable of the material is read out from the storage unit (internal database) 5 and input to the calculation unit 4 by selecting the target material from the input unit 2.

The calculation unit 4 displays the partial structure and explanatory variables used for modeling on the output unit (display unit) 7 as an input screen (selection screen) as shown in FIG. 8 and performs calculation processing to build a prediction model based on the partial structure of the material and the selected explanatory variables. The calculation processing result is stored in the storage unit (memory) 3 and output (displayed) to the output unit (display unit) 7.

Here, the first-principles calculation unit 8 of the calculation unit 4 performs the first-principles calculation based on the partial structure of the material and the randomly selected explanatory variables. The machine learning unit 9 performs unsupervised classification machine learning and supervised learning based on the calculation results of the first-principles calculation unit 8, and a prediction model is built.

As shown in FIG. 11, by connecting to an external storage device (remote database) 6 via a communication network or the like, it is possible to configure the material property prediction device 1 to input necessary data from the outside.

The present invention is not limited to the above-described examples and includes various modifications. For example, the above examples have been described in detail to assist in the understanding of the present invention and are not necessarily limited to those having all the configurations described. It is possible to replace a part of the configuration of one example with the configuration of another example, and it is also possible to add the configuration of another example to the configuration of one example. It is possible to add, delete, and replace a part of the configuration of each example with another configuration.

### REFERENCE SIGNS LIST

1 . . . material property prediction device
2 . . . input unit
3 . . . storage unit (memory)
4 . . . calculation unit
5 . . . storage unit (internal database)
6 . . . external storage device (remote database)
7 . . . output unit (display)
8 . . . first-principles calculation unit
9 . . . machine learning unit

1. A material property prediction method using machine learning that builds a prediction model of an objective variable from explanatory variables based on a partial structure of a material, the method comprising:
(a) a step of performing a first-principles calculation based on the partial structure of the material and randomly selected explanatory variables, and
(b) a step of performing unsupervised classification machine learning and supervised learning based on the result of the first-principles calculation obtained in the above step (a) to build a prediction model, wherein
the sum of squares of the values obtained by the first-principles calculation is included in the explanatory variables in the step (b).

2. The material property prediction method according to claim 1, wherein
the sum of squares of charges obtained by the first-principles calculation is included in the explanatory variables.

3. The material property prediction method according to claim 1, wherein
the sum of squares of bond orders of the materials obtained by the first-principles calculation is included in the explanatory variables.

4. The material property prediction method according to claim 1, wherein
the first-principles calculation is a density functional theory using atomic orbital basis functions.

5. The material property prediction method according to claim 1, wherein
any of ionization potential, electron affinity, molecular volume, and steric hindrance obtained by molecular dynamics for the molecule of the material is included in the explanatory variables.

6. The material property prediction method according to claim 1, wherein
any partial structure of a diatomic bond, a triatomic bond, and a quaternary bond of the material is included in the partial structure.

7. The material property prediction method according to claim 1, wherein
a reduction decomposition resistance of the material is included in the objective variable.

8. The material property prediction method according to claim 1, wherein
a material is selected based on the objective variable predicted by the prediction model built in the step (b).

9. The material property prediction method according to claim 1, wherein
a reaction rate of the material is predicted.

10. A material property prediction device using machine learning that builds a prediction model of an objective variable from explanatory variables based on a partial structure of a material, the device comprising:
an input unit for inputting a molecular set of a target material and selecting explanatory variables;
a calculation unit for building a prediction model based on the partial structure of the material and the selected explanatory variables; and
an output unit for outputting the calculation result in the calculation unit, wherein
the calculation unit includes
a first-principles calculation unit that performs first-principles calculations based on the partial structure of the material and the selected explanatory variables, and
an machine learning unit that performs unsupervised classification machine learning and supervised learning based on the calculation results in the first-principles calculation unit to build a prediction model, and
the sum of squares of the values obtained by the first-principles calculation unit is included in the explanatory variables when building a prediction model in the machine learning unit.

11. The material property prediction device according to claim 10, wherein
the sum of squares of charges obtained by the first-principles calculation unit is included in the explanatory variables.

12. The material property prediction device according to claim 10, wherein
the sum of squares of bond orders of the materials obtained by the first-principles calculation unit is included in the explanatory variables.

13. The material property prediction device according to claim 10, wherein
the first-principles calculation unit uses a density functional theory using atomic orbital basis functions.

14. The material property prediction device according to claim 10, wherein
any of ionization potential, electron affinity, molecular volume, and steric hindrance obtained by molecular dynamics for the molecule of the material is included in the explanatory variables.

15. The material property prediction device according to claim 10, wherein
any partial structure of a diatomic bond, a triatomic bond, and a quaternary bond of the material is included in the partial structure.

16. The material property prediction device according to claim 10, wherein
a reduction decomposition resistance of the material is included in the objective variable.

17. The material property prediction device according to claim 10, wherein
the calculation unit selects a material based on the objective variable predicted by the prediction model built by the calculation unit.

18. The material property prediction device according to claim 10, wherein
a reaction rate of the material is predicted.
